(19) United States
(12) Patent Application Publication
(10) Pub. No.: US 2017/0205775 A1
(43) Pub. Date: Jul. 20, 2017

(54) Wireless Stopwatch

(71) Applicant: Electronics Tomorrow Limited, Hong Kong (HK)

(72) Inventor: Andrew Yick Siu Wei, Hong Kong (HK)

(73) Assignee: Electronics Tomorrow Limited

(21) Appl. No.: 15/002,227

(22) Filed: Jan. 20, 2016

(51) Int. Cl. G04G 21/04; G04F 10/00; H04W 4/00

(52) U.S. Cl. CPC G04G 21/04; H04W 4/008; G04F 10/00

(57) ABSTRACT

A wireless stopwatch for being controlled and monitored by a remote controller includes a casing, a display device, at least one control button, a wireless transceiver provided on the casing and wirelessly communicated with the remote controller, and a central processing module. The central processing module is electrically connected to the wireless transceiver, the control button and the display device, and is configured to control the display device for displaying timer information thereon. The timer information is wirelessly transmitted to the remote controller via the wireless transceiver for further processing. The central processing module is configured to receive control command, via the wireless transceiver, from the remote controller, and execute the control command correspondingly.

### BACKGROUND OF THE PRESENT INVENTION

Field of Invention

The present invention relates to a stopwatch, and more particularly to a stopwatch which is capable of wirelessly communicating with a remote controller for transmitting timer information to the remote control, or for receiving controller commands from the remote controller.

Description of Related Arts

A conventional stopwatch may be used to measure the amount of time elapsed from a reference time. A time counter is implemented in the stopwatch for counting time when the stopwatch is activated.

Conventional stopwatches are handheld devices and may comprise a memory module for storing timer information. For example, several timer information may be stored in the memory module for comparison or analysis purpose.

A major disadvantage for the above-mentioned conventional stopwatch is that the stopwatch is a stand-along device which may not have more sophisticated functions for analyzing or storing timer information. For example, a user of the stopwatch such as an athlete may need to manually record his or her performance throughout an extended period of time for analyzing his or her performance.

As a result, there is a need to develop a stopwatch which may facilitate a user to perform extended analysis of his or her performance.

### SUMMARY OF THE PRESENT INVENTION

An objective of the present invention is to provide a stopwatch which is capable of wirelessly communicating with a remote control for transmitting timer information to the remote control, or for receiving control commands from the remote control.

Another objective of the present invention is to provide a stopwatch which may facilitate a user to perform extended analysis of his or her performance.

In one aspect of the present invention, it provides a wireless stopwatch for being controlled and monitored by a remote controller, comprising:

a casing;

a display device provided on the casing;

at least one control button provided on the casing;

a wireless transceiver provided on the casing and wirelessly communicated with the remote controller; and

a central processing module electrically connected to the wireless transceiver, the control button and the display device, the central processing module being configured to control the display device for displaying timer information thereon, the timer information being wirelessly transmitted to the remote controller via the wireless transceiver for further processing, the central processing module being configured to receive control command, via the wireless transceiver, from the remote controller, and execute the control command correspondingly.

In another aspect of the present invention, it provides a wireless stopwatch kit, comprising:

a remote controller; and

a wireless stopwatch kit, which comprises:

a casing;

a display device provided on the casing;

at least one control button provided on the casing;

a wireless transceiver provided on the casing and wirelessly communicated with the remote controller; and

a central processing module electrically connected to the wireless transceiver, the control button and the display device, the central processing module being configured to control the display device for displaying timer information thereon, the timer information being wirelessly transmitted to the remote controller via the wireless transceiver for further processing, the central processing module being configured to receive control command, via the wireless transceiver, from the remote controller, and execute the control command correspondingly.

### BRIEF DESCRIPTION OF THE DRAWINGS

FIG. 1 is a perspective view of a wireless stopwatch according to a preferred embodiment of the present invention.

FIG. 2 is an exploded perspective view of the wireless stopwatch according to the preferred embodiment of the present invention.

FIG. 3 is a block diagram of the wireless stopwatch according to the preferred embodiment of the present invention.

FIG. 4A to FIG. 4D are circuit diagrams for the wireless stopwatch according to the preferred embodiment of the present invention.

FIG. 5A to FIG. 5G are schematic diagrams of the wireless stopwatch according to the preferred embodiment of the present invention, illustrating the screens shown on the display device.

FIG. 6A to FIG. 6B illustrate the screens produced on the remote controller which may be able to wirelessly control the operation of the wireless stopwatch according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

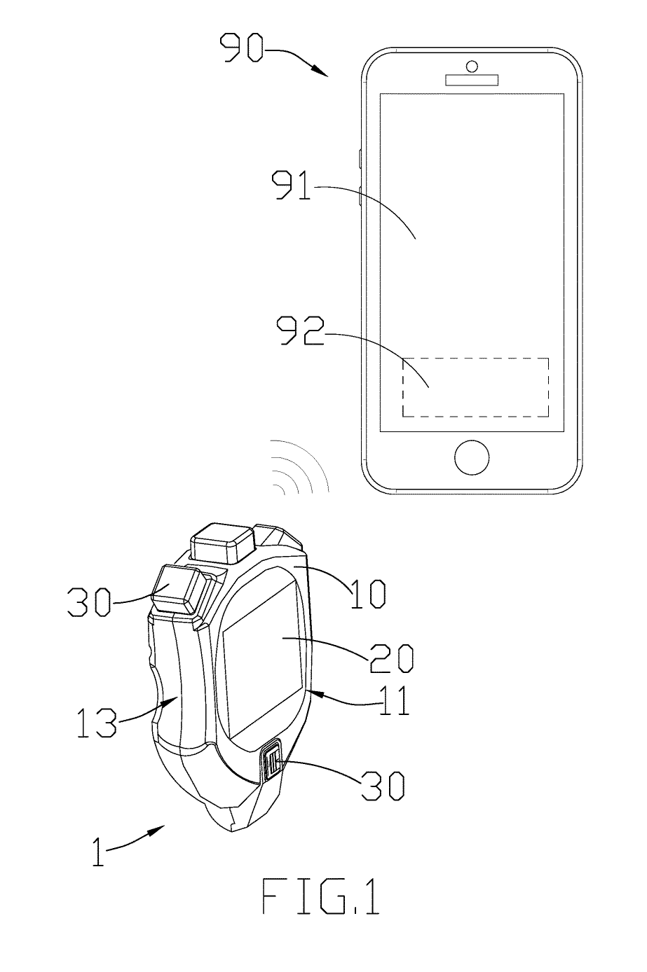

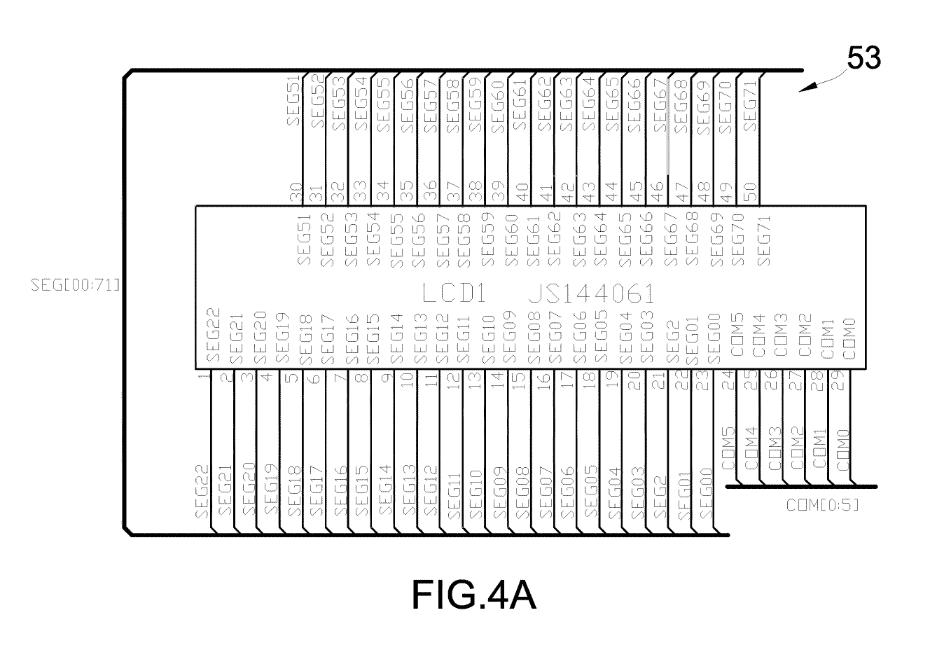

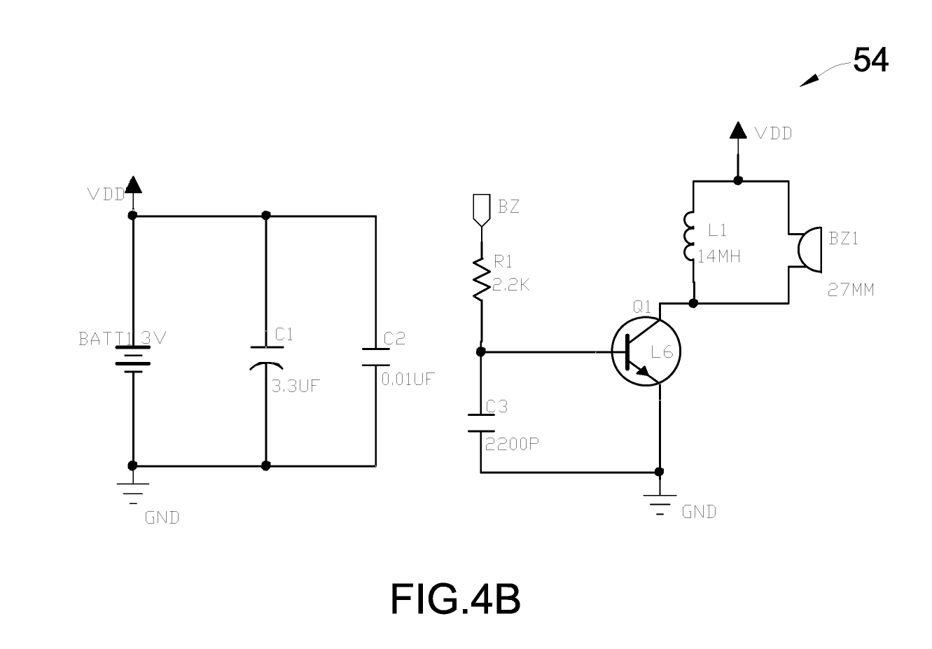

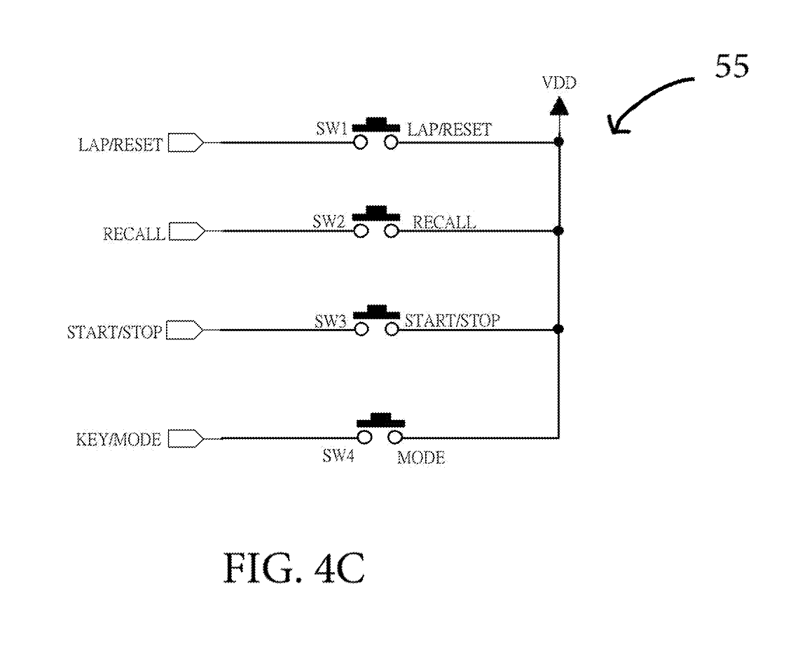

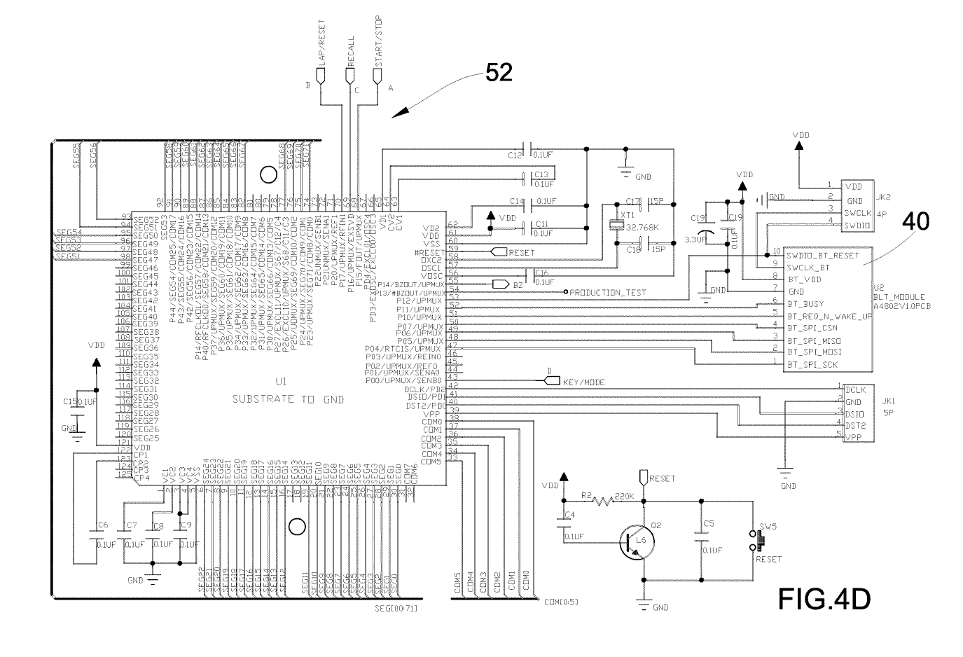

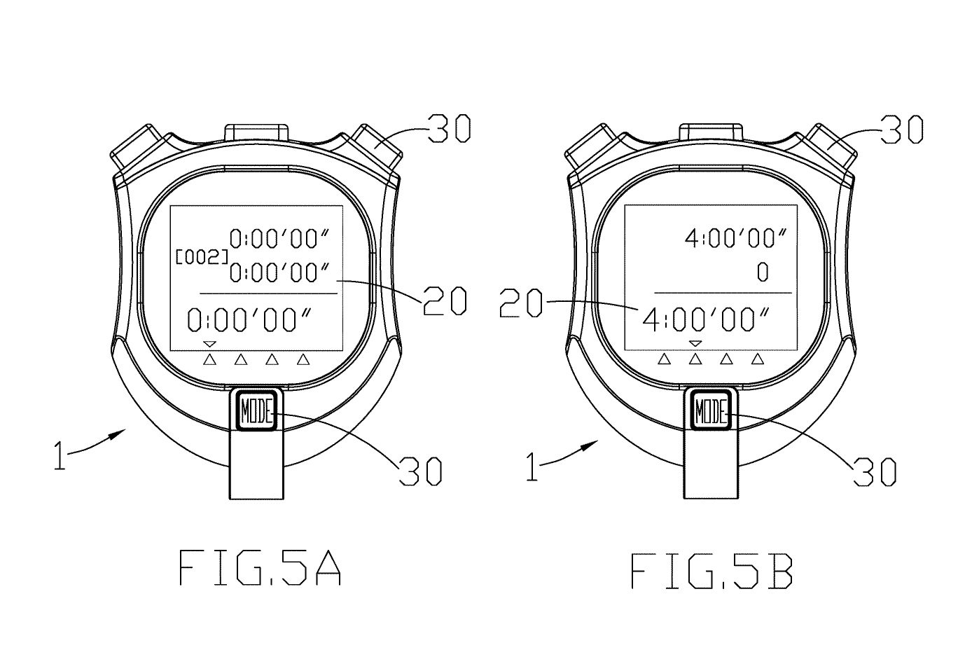

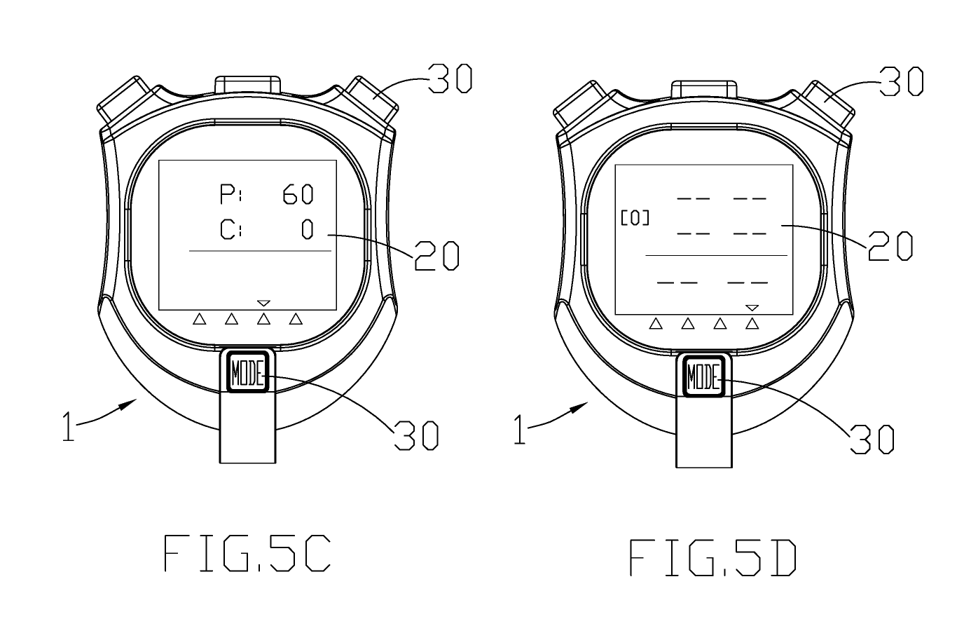

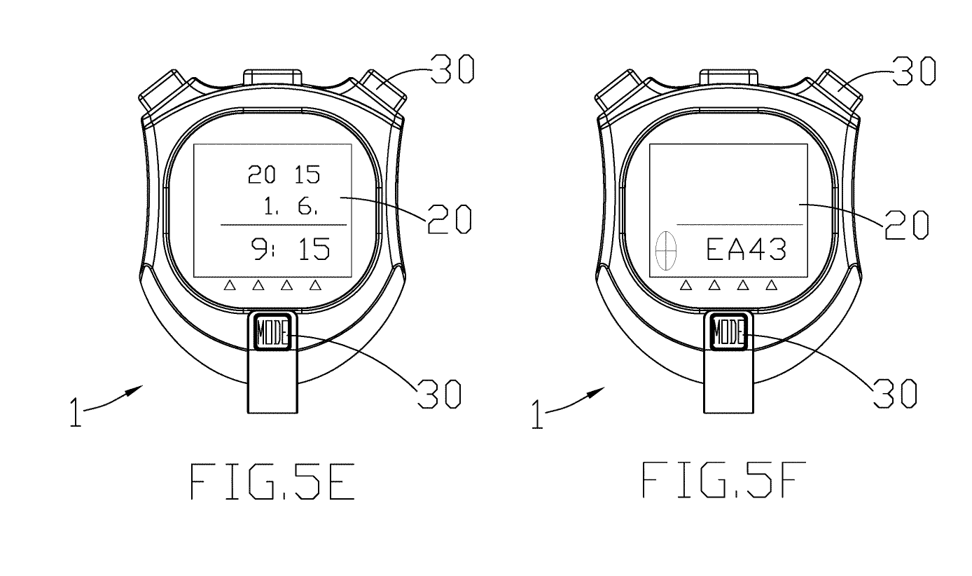

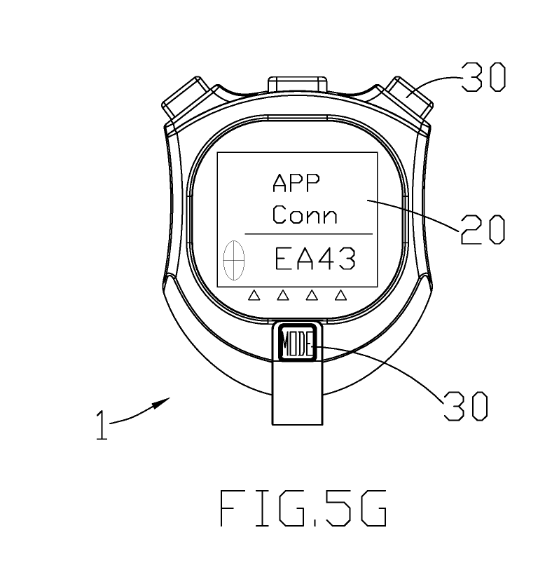

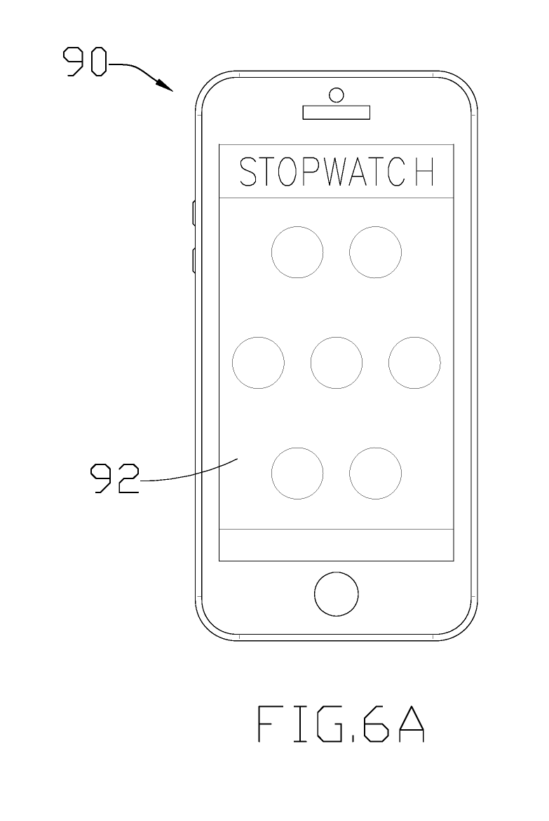

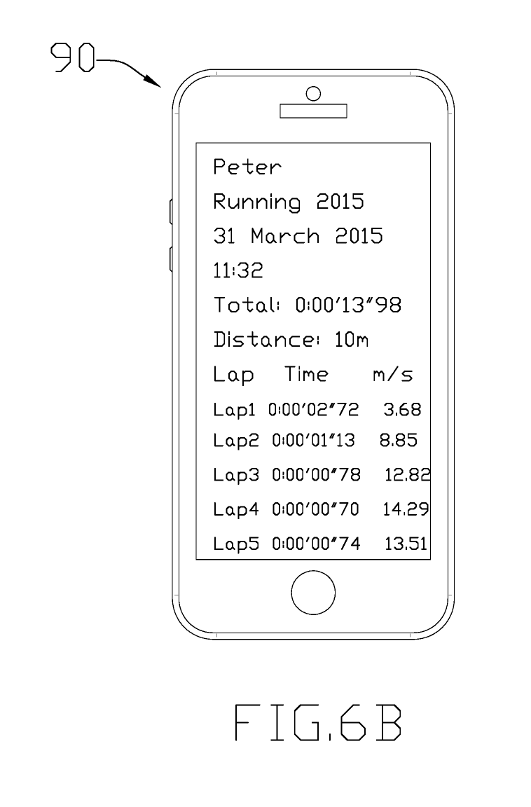

Referring to FIG. 1 to FIG. 3, FIG. 4A to FIG. 4D, FIG. 5A to FIG. 5G and FIG. 6A to FIG. 6B of the drawings, a wireless stopwatch 1 according to a preferred embodiment of the present invention is illustrated. Broadly, the wireless stopwatch 1 may comprise a casing 10, and a display device 20 provided on the casing 10, at least one control button 30 provided on the casing 10, a wireless transceiver 40, and a central processing module 50. The wireless stopwatch 1 may be wirelessly controlled and monitored by a remote controller 90, such as a smartphone having a predetermined program. Thus, the remote controller 90 may comprise a screen 91 such as a touch screen for providing an input interface 92 for allowing a user to input control commands for setting up the wireless stopwatch 1 or for analyzing timer information.

The wireless transceiver 40 may be provided in the casing and is wirelessly communicated with the remote controller 90, so that timer information or control commands may be wirelessly communicated between the wireless stopwatch 1 and the remote controller 90.

The central processing module 50 may be electrically connected to the wireless transceiver 40, the control button 30 and the display device 20. Moreover, the central processing module 50 may be configured to control the display device 20 for displaying timer information thereon. The timer information may be wirelessly transmitted to the remote controller 90 via the wireless transceiver 40 for further processing. The central processing module 50 may be configured to receive control commands, via the wireless transceiver 40, from the remote controller 90, and execute the control commands correspondingly.

According to the preferred embodiment of the present invention, the casing 10 may be designed to be portable and have a front surface 11, a rear surface 12, and a side surface 13. The display device 20 may be provided on the front surface 12 of the casing 10 for displaying timer or other information. The display device 20 may be embodied as a LCD display device.

The wireless stopwatch 1 may comprise three control buttons 30 provided on the side surface 13 of the casing 10. The control buttons 30 are provided for allowing a user to control the operation of the wireless stopwatch 1. For example, the control buttons 30 may be utilized for starting a timer counting or for setting a particular timer.

The wireless transceiver 40 may be embodied as a BLUETOOTH wireless transceiver which is capable of transmitting and receiving BLUETOOTH wireless signals to and from the remote controller 90. Thus, the wireless stopwatch 1 of the present invention is capable of being communicating with the remote controller 90 by using BLUETOOTH wireless technology. One of the control buttons 30 provided on the casing may be used to activate pairing or connection between the wireless stopwatch 1 and the remote controller 90. One skill in the art may also appreciate that other suitable wireless technology may also be utilized.

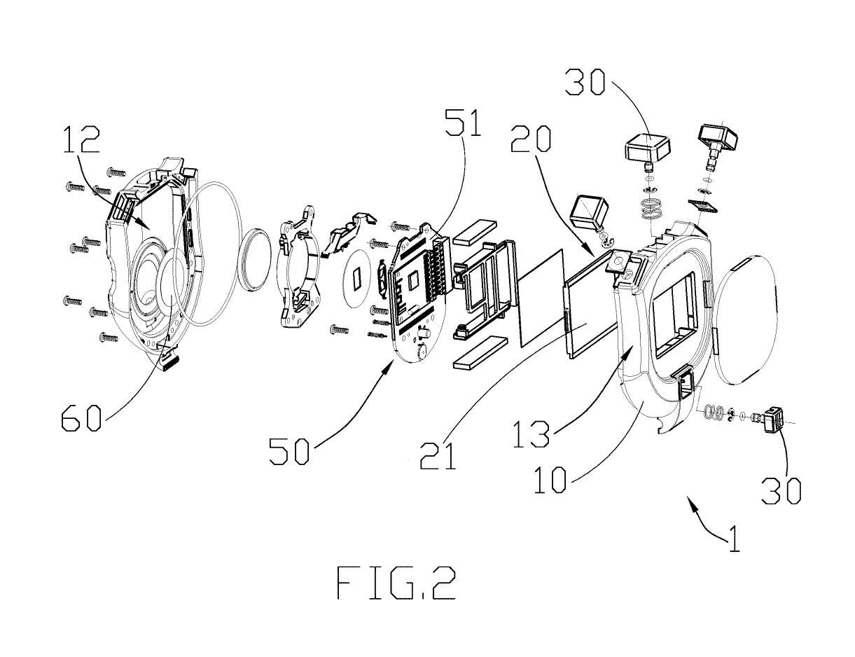

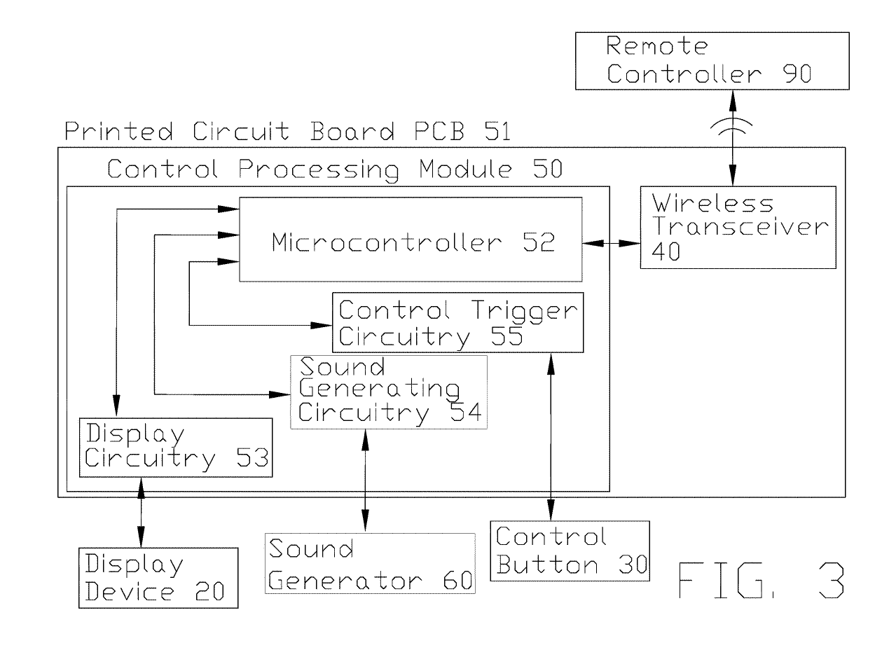

The central processing module 50 may comprise a Printed Circuit Board (PCB) 51, a microcontroller 52 implemented on the PCB 51, display circuitry 53 implemented on the PCB 51, a sound generating circuitry 54, and a control trigger circuitry 55. As shown in FIG. 2 and FIG. 3 of the drawings, the microcontroller 52, the display circuitry 53, the sound generating circuitry 54 and the control trigger circuitry 55 may all be implemented onto the PCB 51. The circuit diagrams for these circuitries are illustrated in FIG. 4A to FIG. 4D of the drawings.

As shown in FIG. 3 and FIG. 4A of the drawings, the display circuitry 53 may be electrically connected to the microcontroller 52 and the displace device 20, which comprises a LCD display screen 21 for displaying timer information thereon. The timer information is generated by the microcontroller 52 and is displayed on the LCD display screen 21 as driven by the display circuitry 53.

As shown in FIG. 3 and FIG. 4B of the drawings, the sound generating circuitry 54 may be electrically connected to the microcontroller 52 and is configured to drive a sound generator 60 such as a buzzer provided in the casing 10. The microcontroller 52 may signal the sound generator 60 to generate specific audible sound when a particular mode of timing operation is completed. For example, when a timer operation of 10 seconds is completed, the sound generator 60 is arranged to generate a “beep” sound.

As shown in FIG. 3 and FIG. 4C of the drawings, the control trigger circuitry 55 may be electrically connected to the microcontroller 52 and the control buttons 30 and is configured to activate certain predetermined functions when the control buttons 30 are actuated. Thus, for example, when the control buttons 30 are actuated (i.e. depressed), the control trigger circuitry 55 are configured to send a signal to the microcontroller 52 so as to start or stop an operation of the wireless stopwatch 1.

FIG. 4D illustrates the circuit diagram for the microcontroller 52. The microcontroller 52 may be electrically connected to the wireless transceiver 40 so as to transmit or receive signals to or from the remote controller 90.

Referring to FIG. 5A to FIG. 5G of the drawings, the wireless stopwatch 1 of the present invention may be operated in one of six modes of operation. A user may actuate one of the control buttons 30 to switch between modes of operation. FIG. 5A illustrates that the wireless stopwatch 1 is being operated in a stopwatch mode. In this mode, when the user actuates a designated control button 30, the timer will start. When the user actuates the same or another designated control button 30, the timer will stop. The corresponding time may be recorded.

FIG. 5B illustrates that the wireless stopwatch 1 is being operated in a countdown timer mode. In this mode, the user may actuate a designated control button 30 to set up a countdown time. The user may then actuate the same or another designated control button 30 to start the countdown timer. The sound generator 60 may generate an audible sound when the countdown has finished.

FIG. 5C illustrates that the wireless stopwatch 1 is being operated in a single pacer mode. In this mode, the user may be able to set, through operation of one or more of the control buttons 30, a pacer program to fit his or her individual need. FIG. 5D illustrates that the wireless stopwatch 1 is being operated in a stroke mode. In the stroke mode, the user is able to input stroke data through operating one or more of the control buttons 30.

FIG. 5E illustrates that the wireless stopwatch 1 is being operated in a calendar mode. In this mode, the user may be able to actuate a control button 30 to control the display device 20 to display date information.

FIG. 5F and FIG. 5G illustrate that the wireless stopwatch 1 is being operated in a BLUETOOTH connection mode. In this mode, the user may actuate a designated control button to activate BLUETOOTH pairing with another BLUETOOTH device, such as the remote controller 90. In this mode, the user may wireless connect to the remote controller 90 so that data from the wireless stopwatch 1 may be transmitted to the remote controller 90 for storing, while control commands from the remote controller 90 may be wirelessly transmitted to the wireless stopwatch 1 for controlling an operation thereof. For example, timer records may be transmitted to the remote controller 90 for further analysis. Similarly, a pacer program or stroke data may be set in the remote controller 90 and transmitted to the wireless stopwatch 1 via BLUETOOTH connection in this BLUETOOTH connection mode.

Referring to FIG. 6A to FIG. 6B of the drawings, they illustrate the screens shown on the remote controller 90 regarding the operation of the wireless stopwatch 1. As shown in FIG. 6A of the drawings, the remote controller 90 is pre-loaded with a specific mobile program which illustrates the options available to the user of the present invention. For example, the user may choose to review the time records or set pacer program for the wireless stopwatch 1 by operating on the input interface 92 (e.g. by pressing on the corresponding icons). When the remote controller 90 has been connected to the wireless stopwatch 1 of the present invention, the user is able to set up particular programs and transmit these programs to the wireless stopwatch 1 via BLUETOOTH wireless technology. As shown in FIG. 6B of the drawings, the screen illustrates the results for different laps. It also illustrates the date, time and distance (i.e. training parameters) of a particular user.

It is worth mentioning that the present invention may cover a wireless stopwatch kit which may comprise the wireless stopwatch 1 and the remote controller 90 as described above. The remote controller 90 and the wireless stopwatch 1 may be wirelessly communicated via BLUETOOTH technology as described above.

The present invention, while illustrated and described in terms of a preferred embodiment and several alternatives, is not limited to the particular description contained in this specification. Additional alternative or equivalent components could also be used to practice the present invention.

1. A wireless stopwatch for being controlled and monitored by a remote controller, comprising:
a casing having a front surface, a rear surface and a side surface;
a display device comprising a LCD display screen provided on said front surface of said casing;
at least one control button provided on said casing;
a wireless transceiver provided on said casing and wirelessly communicated with said remote controller, said wireless transceiver being a BLUETOOTH wireless transceiver which is capable of transmitting and receiving BLUETOOTH wireless signals to and from said remote controller; and
a central processing module electrically connected to said wireless transceiver, said control button and said display device, said central processing module comprising a printed circuit board (PCB), and a microcontroller implemented on said printed circuit board, and being configured to control said display device for displaying timer information thereon, said timer information being wirelessly transmitted to said remote controller via said wireless transceiver for further processing, said central processing module being configured to receive control command, via said wireless transceiver, from said remote controller, and execute said control command correspondingly,
said central processing module being further configured to operate said wireless stopwatch in at least one of a BLUETOOTH connection mode, a stopwatch mode, and a countdown timer mode,
wherein in said BLUETOOTH connection mode, when a predetermined control button is actuated, said wireless transceiver is arranged to wirelessly pair with said remote controller so as to establish wireless connection between said central processing module and said remote controller,
wherein in said stopwatch mode, when said control button is actuated, a timer starts, and when said control button is actuated again, said timer stops and said timer information is arranged to be wirelessly sent to said remote controller, and
wherein in said countdown timer mode, a countdown time is preset and when a predetermined control button is actuated, said countdown time starts to run and said countdown information is wirelessly sent to said remote controller.

2-4. (canceled)

5. The wireless stopwatch, as recited in claim 1, wherein said central processing module further comprises a display circuitry implemented on said printed circuit board, said display circuitry being electrically connected to said microcontroller and said displace device for driving said LCD display screen to display timer information.

6. The wireless stopwatch, as recited in claim 1, further comprising a sound generator provided in said casing, said central processing module further comprising a sound generating circuitry implemented on said printed circuit board and is electrically connected to said microcontroller, said sound generating circuitry being configured to drive said sound generator to generate audible sound.

7. The wireless stopwatch, as recited in claim 5, further comprising a sound generator provided in said casing, said central processing module further comprising a sound generating circuitry implemented on said printed circuit board and is electrically connected to said microcontroller, said sound generating circuitry being configured to drive said sound generator to generate audible sound.

8. The wireless stopwatch, as recited in claim 1, wherein said central processing module further comprises a control trigger circuitry implemented on said printed circuit board, said control trigger circuitry being electrically connected to said microcontroller and said control button, and configured to activate a predetermined function when said control button is actuated.

9. The wireless stopwatch, as recited in claim 6, wherein said central processing module further comprises a control trigger circuitry implemented on said printed circuit board, said control trigger circuitry being electrically connected to said microcontroller and said control button, and configured to activate a predetermined function when said control button is actuated.

10. The wireless stopwatch, as recited in claim 7, wherein said central processing module further comprises a control trigger circuitry implemented on said printed circuit board, said control trigger circuitry being electrically connected to said microcontroller and said control button, and configured to activate a predetermined function when said control button is actuated.

11-19. (canceled)

20. A wireless stopwatch kit, comprising:
a remote controller; and
a wireless stopwatch kit, which comprises:
a casing having a front surface, a rear surface and a side surface;
a display device comprising a LCD display screen provided on said front surface of said casing;
at least one control button provided on said casing;
a wireless transceiver provided on said casing and wirelessly communicated with said remote controller, said wireless transceiver being a BLUETOOTH wireless transceiver which is capable of transmitting and receiving BLUETOOTH wireless signals to and from said remote controller; and
a central processing module electrically connected to said wireless transceiver, said control button and said display device, said central processing module comprising a printed circuit board (PCB), and a microcontroller implemented on said printed circuit board, and being configured to control said display device for displaying timer information thereon, said timer information being wirelessly transmitted to said remote controller via said wireless transceiver for further processing, said central processing module being configured to receive control command, via said wireless transceiver, from said remote controller, and execute said control command correspondingly,
said central processing module being further configured to operate said wireless stopwatch in at least one of a BLUETOOTH connection mode, a stopwatch mode, and a countdown timer mode,
wherein in said BLUETOOTH connection mode, when a predetermined control button is actuated, said wireless transceiver is arranged to wirelessly pair with said remote controller so as to establish wireless connection between said central processing module and said remote controller,
wherein in said stopwatch mode, when said control button is actuated, a timer starts, and when said control button is actuated again, said timer stops and said timer information is wireless sent to said remote controller, and
wherein in said countdown timer mode, a countdown time is preset and when a predetermined control button is actuated, said countdown time starts to run and said countdown information is wirelessly sent to said remote controller.

21. The wireless stopwatch kit, as recited in claim 20, wherein said central processing module further comprises a display circuitry implemented on said printed circuit board, said display circuitry being electrically connected to said microcontroller and said displace device for driving said LCD display screen to display timer information.

22. The wireless stopwatch, as recited in claim 21, further comprising a sound generator provided in said casing, said central processing module further comprising a sound generating circuitry implemented on said printed circuit board and is electrically connected to said microcontroller, said sound generating circuitry being configured to drive said sound generator to generate audible sound.

23. The wireless stopwatch, as recited in claim 22, wherein said central processing module further comprises a control trigger circuitry implemented on said printed circuit board, said control trigger circuitry being electrically connected to said microcontroller and said control button, and configured to activate a predetermined function when said control button is actuated.
